(19) United States
(12) Patent Application Publication
(10) Pub. No.: US 2015/0247622 A1
(43) Pub. Date: Sep. 3, 2015

(54) EXTENDED LENS OPTICS FOR WALL WASH LIGHTING

(71) Applicant: JUNO MANUFACTURING LLC, Des Plaines, IL (US)

(72) Inventors: Chi ZHANG, Evanston, IL (US); Charles J. SPENCER, Wilmette, IL (US)

(21) Appl. No.: 14/630,140

(22) Filed: Feb. 24, 2015

Related U.S. Application Data
(60) Provisional application No. 61/945,933, filed on Feb. 28, 2014.

(51) Int. Cl. F21V 13/04; F21K 99/00; F21V 21/04; F21S 8/02

(52) U.S. Cl. CPC F21V 13/04; F21S 8/026; F21K 9/50; F21V 21/047; F21Y 2101/02

(57) ABSTRACT

A wall wash lighting assembly for a recessed light fixture includes a downlight trim, a kicker reflector and a light diffusing lens. The trim has an upper opening, a lower opening and a cavity therebetween. The kicker reflector is arranged in the cavity of the trim, and is used to reflect light toward an adjacent wall through the lower opening of the trim. The lens receives light from an LED light source and outputs diffused light into the cavity of the trim. The lens includes an elongated portion which extends vertically toward the lower opening. The lens provides a pool of direct light onto the adjacent wall via the elongated portion and a pool of reflected light indirectly onto the adjacent wall via the kicker reflector without having a dark space on the adjacent wall between the pool of direct light and the pool of reflected light.

### RELATED CASES

The present application claims priority under 35 U.S.C. §119(e) based on U.S. Provisional Application Ser. No. 61/945,933 filed on Feb. 28, 2014, which is incorporated by reference herein in its entirety.

### FIELD

The present disclosure is related to a recessed light fixture, and more particularly, to an optical configuration for a downlight wall wash lighting assembly.

### BACKGROUND

A downlight wall wash is a type of recessed light fixture, which is mounted in a ceiling. The wall wash is used to distribute light onto a wall that is adjacent to the light fixture. Lighting designers use various criteria to evaluate the quality of such a light fixture, such as how well the fixture can distribute light on the adjacent wall. Ideally, lighting designers would like to have the light distributed evenly on the wall with the light directed very close to the ceiling and a smooth transition down the wall toward the floor. Multiple wall washers, which are arranged next to each other, can be used to eliminate arch type of distribution (called scallops) and create a wall pattern that is very uniform horizontally across the wall and vertically, with no variation in foot candles.

Light-emitting diodes (LEDs) have become a viable light source for downlights. However, manufacturers continue to design wall wash reflectors using the same type of configurations and shapes that are used with a traditional light source that generates light in all directions. For example, a wall wash lighting assembly can include a parabolic downlight trim, with a window cutout for a partial parabolic kicker reflector, to direct a portion of the light down and a portion of the light toward an adjacent wall. When used with an LED light source, this reflector configuration can provide relatively high-ceiling illumination but suffers from uniformity distribution on the adjacent wall, e.g., a non-uniform pattern on the adjacent wall with two “pools of light”.

For example, as shown in FIG. 3, direct light from the LED light source creates a pool of light on a bottom portion of the adjacent wall, and reflected light from the kicker reflector creates a pool of light at a top of the adjacent wall. There is a dark space, generally identified by reference number 350 in FIG. 3, between the pool of direct light and the pool of reflected light on the adjacent wall. The dark space is a gap (e.g., an absence of light) between the two light pools from the direct light and the reflected light, and is shaped like a dark curve due to the nature of the LED light source. The dark curve becomes even more prevalent with larger trim aperture sizes where the trim aperture size is much larger than the light source. Any effort to lower the top pool of light by re-aiming the kicker reflector, however, would move the light further from the ceiling, which is undesirable to light designers. Any effort to lower the LED light source to raise the lower pool of light also would result in more glare, which is also undesirable.

### SUMMARY

To address these and other shortcomings, an improved wall wash lighting assembly for a recessed light fixture employs a light diffusing lens with an elongated portion, which works in combination with a kicker reflector, to distribute light from an LED light source evenly on an adjacent wall without a dark space (e.g., a dark gap) between direct light and reflected light. The light diffusing lens with the elongated portion is used to change the light source distribution vertically and horizontally to achieve a uniform distribution on a target area. For example, by elongating a portion of the light diffusing lens further downward into the reflector assembly of the downlight trim, it is possible to elongate the source image produced by the recessed light fixture, thereby eliminating the dark space either by altering an angle of reflection on the kicker reflector, or by covering the dark space with direct light from the elongated portion of the light diffusing lens. Such a wall wash lighting assembly can be used in single, double and corner wall wash applications, and for any aperture size of the downlight trim.

The wall wash lighting assembly can include a downlight trim, a kicker reflector and a light diffusing lens. The down light trim has an upper opening, a lower opening and a cavity therebetween. The kicker reflector is arranged in the cavity of the downlight trim, and is used to reflect light toward an adjacent wall through the lower opening of the downlight trim. The light diffusing lens receives light from an LED light source and outputs diffused light into the cavity of the downlight trim. The light diffusing lens includes an elongated portion which extends vertically toward the lower opening. The light diffusing lens provides a pool of direct light directly onto the adjacent wall via the elongated portion and a pool of reflected light indirectly onto the adjacent wall via the kicker reflector without having a dark space on the adjacent wall between the pool of direct light and the pool of reflected light. The light diffusing lens can, for example, have a cross-sectional bell curve shape or other shape, with a maximum height between about one-third and one-half of a height of the downlight trim.

Furthermore, in addition to eliminating the dark space, the wall wash lighting assembly can use a light diffusing lens with a desired lens height for the elongated portion to control vertical distribution of light on the adjacent wall. For example, the light diffusing lens can be extended further into the cavity toward the lower opening (e.g., with a larger lens height) to project light, such as reflected light from the kicker reflector, higher or closer to the ceiling on the adjacent wall for high-ceiling illumination.

### BRIEF DESCRIPTION OF THE DRAWINGS

The description of the various exemplary embodiments is explained in conjunction with the appended drawings, in which:

FIG. 1 illustrates a recessed light fixture, mounted in a ceiling, which includes a mounting frame, LED light source and a wall wash lighting assembly (which is shown as a cross-sectional side view) incorporating a light diffusing lens with a vertical elongated portion, in accordance with an exemplary embodiment of the present disclosure.

FIG. 2 illustrates an enlarged view of the wall wash lighting assembly of FIG. 1.

FIG. 3 illustrates an example light distribution pattern for a traditional wall wash lighting assembly with a kicker reflector in which light is distributed onto an adjacent wall resulting in dark space.

FIG. 4 illustrates an example light distribution pattern for a wall wash lighting assembly with a kicker reflector and a light diffusing lens with an elongated portion, such as in FIGS. 1 and 2, in which light is uniformly distributed onto an adjacent wall.

FIGS. 5A and 5B illustrate a perspective view and a cross-sectional view, respectfully, of a light diffusing lens of the wall wash lighting assembly, such as in FIG. 1, in accordance with a further embodiment.

FIGS. 6A and 6B illustrate a perspective view and a cross-sectional view, respectfully, of a light diffusing lens of the wall wash lighting assembly, such as in FIG. 1, in accordance with a another embodiment.

### DETAILED DESCRIPTION OF THE EXAMPLE EMBODIMENTS

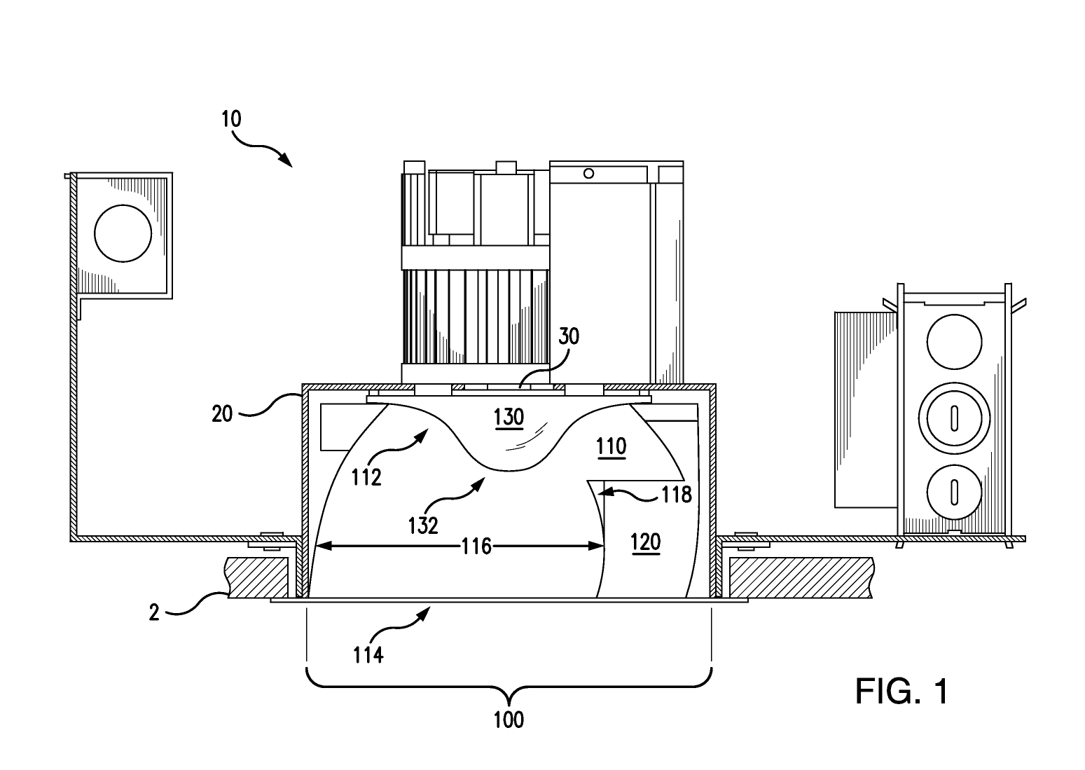

FIG. 1 illustrates a recessed light fixture 10, which is mounted in a ceiling 2 and includes a mounting frame 20 (e.g., a frame or housing), an LED light source 30 and a wall wash lighting assembly 100. The LED light source 30 is connected to the mounting frame 20. The wall wash lighting assembly 100 includes a downlight trim 110, a kicker reflector 120 and an elongated light diffusing lens 130. The wall wash lighting assembly 100 is connected to the mounting frame 20, with the light diffusing lens 130 arranged adjacent to and below the LED light source 30.

The downlight trim 110 is parabolic trim, and includes an upper opening 112, a lower opening 114 (e.g., a trim aperture) and a cavity 116 therebetween. The kicker reflector 120 is arranged in the cavity 116 of the downlight trim 110, and is used to reflect light toward an adjacent wall through the lower opening 114 of the downlight trim 110. In this example, the downlight trim 110 has a window portion 118 cut out and the kicker reflector 120 fitted therein. The kicker reflector 120 is a partial parabolic kicker reflector with a reflective surface.

The light diffusing lens 130 receives light from the adjacent LED light source 30 and outputs diffused light into the cavity 116 of the downlight trim 110. The light diffusing lens 130 extends horizontally to cover the upper opening 112 of the downlight trim 110. For example, the light diffusing lens 130 can be positioned above, in or below the upper opening 112 of the downlight trim 110. The light diffusing lens 130 can be connected to the downlight trim 110 using fasteners (e.g., screws) or with an adhesive. The light diffusing lens 130 includes an elongated portion 132 which extends vertically toward the lower opening 114 of the downlight trim 110. The light diffusing lens 130 provides a pool of direct light directly onto the adjacent wall via the elongated portion 132 and a pool of reflected light indirectly onto the adjacent wall via the kicker reflector 120 without having a dark space on the adjacent wall between the pool of direct light and the pool of reflected light. The light diffusing lens 130 can be formed of glass, plastic, or any optical material to diffuse light. The light diffusing lens can be a light shaping lens to diffuse, shape and control light from the LED light source 30 to provide a uniform and desired light pattern on the adjacent wall and/or downward in a direction in parallel to the adjacent wall toward the floor.

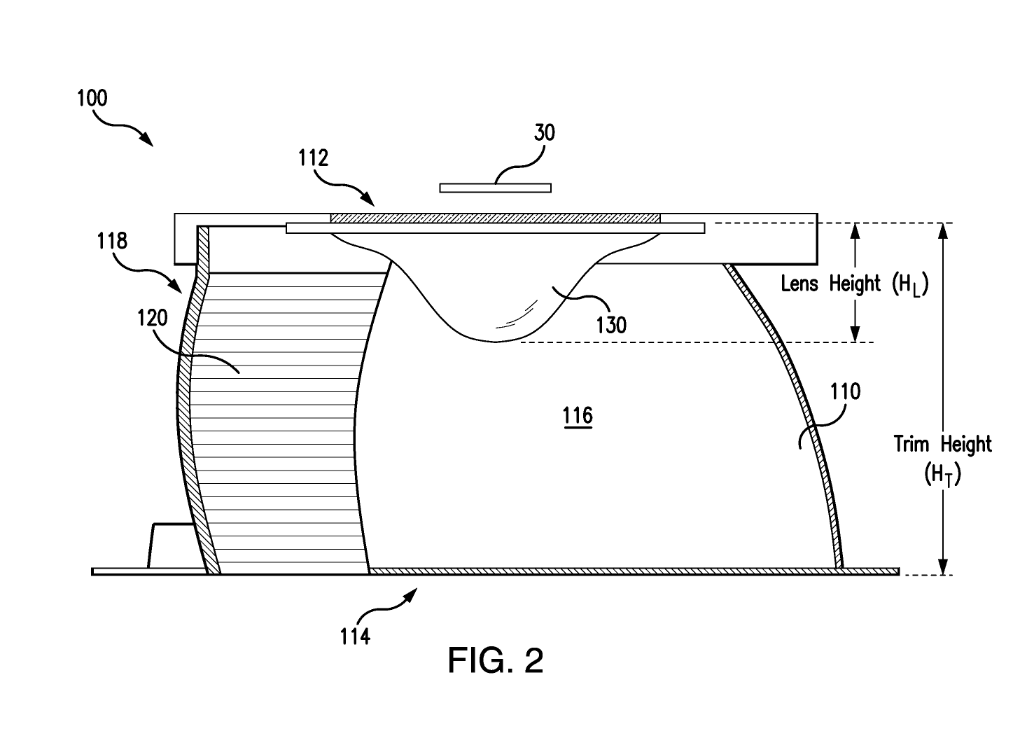

FIG. 2 illustrates an enlarged view of the wall wash lighting assembly 100 of FIG. 1, with the downlight trim 110, the kicker reflector 120 and the light diffusing lens 130. As shown in FIG. 2, the light diffusing lens 130 has a cross sectional shape which may taper as the elongated portion 132 extends from around the upper opening 112 toward the lower opening 114 of the downlight trim 110. For example, the light diffusing lens 130 can have a cross-sectional bell curve shape. The light diffusing lens 130 can preferably have a maximum lens height (H_{L}) between about one-third and one-half of a trim height (H_{T}), e.g., the height from around the upper opening 112 to the lower opening 114.

Furthermore, in addition to eliminating the dark space, the wall wash lighting assembly 100 can have the light diffusing lens 130 configured with a desired lens height for the elongated portion 132 to control vertical distribution of light on the adjacent wall. For example, the light diffusing lens 130 can be extended further into the cavity 116 in a vertical direction toward the lower opening (e.g., with a larger lens height) to project light, such as reflected light from the kicker reflector 120, higher or closer to the ceiling on the adjacent wall for high-ceiling illumination.

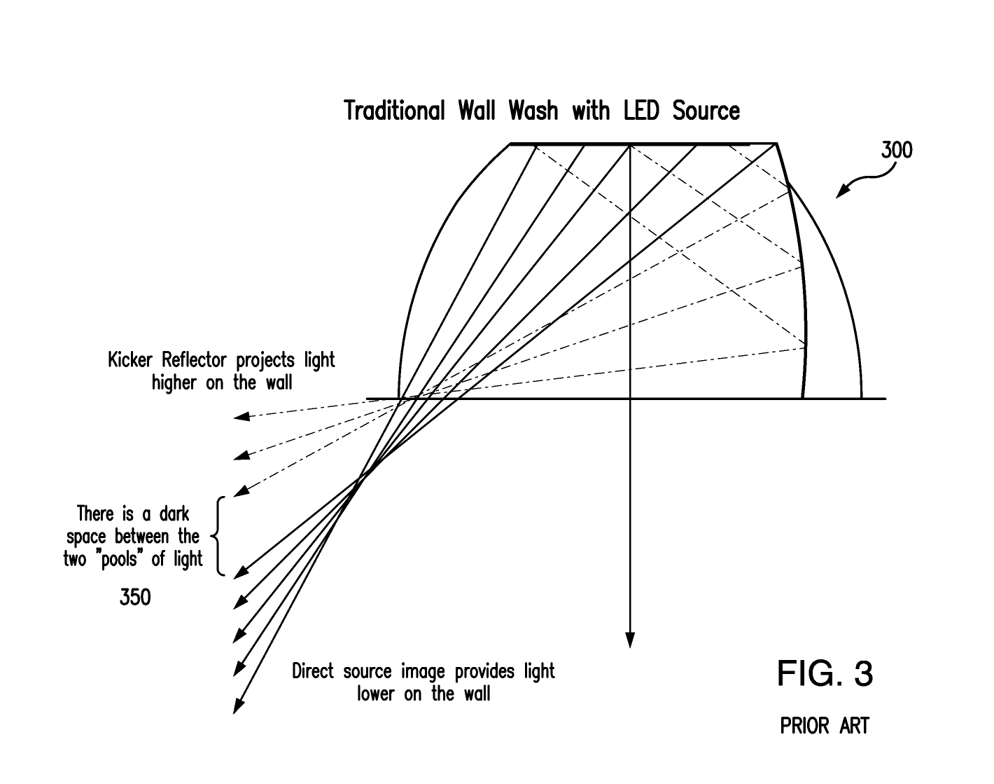

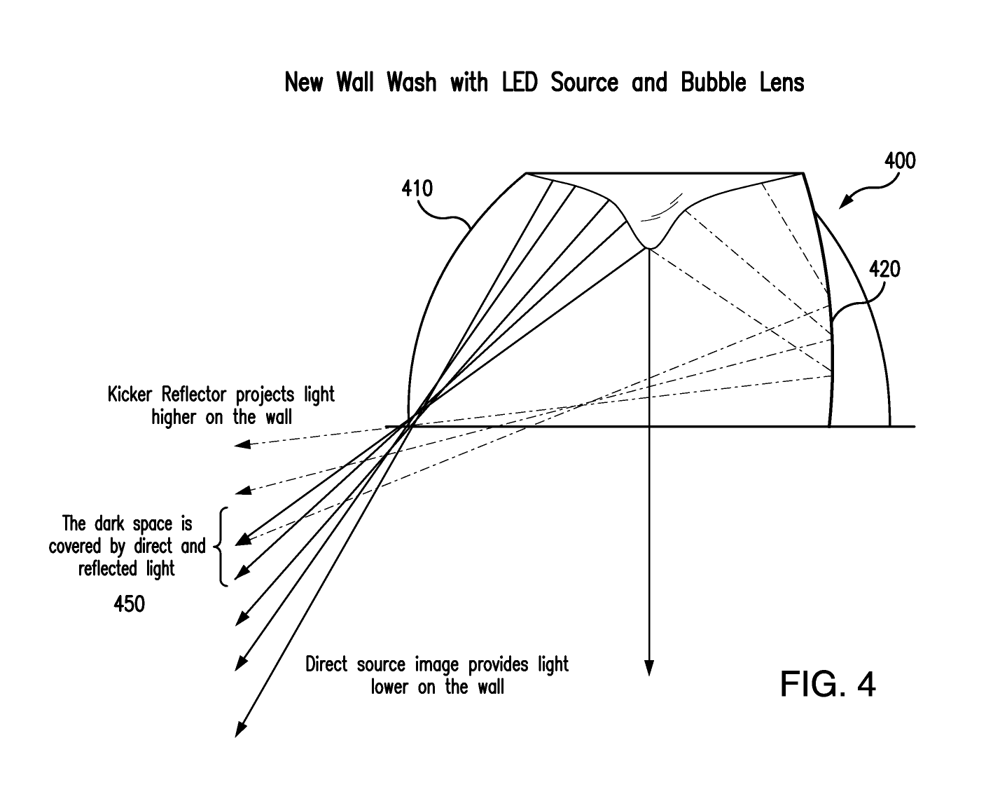

FIG. 4 illustrates an example light distribution pattern for a wall wash lighting assembly 400, which is an exemplary model of the wall wash lighting assembly 100 of FIGS. 1 and 2. The wall wash lighting assembly 400 similarly includes a downlight trim 410, a kicker reflector 420 and an elongated light diffusing lens 430 having a vertical elongated portion 432. As shown in FIG. 4, the light diffusing lens 430 provides a pool of direct light directly onto an adjacent wall via the elongated portion 432 and a pool of reflected light indirectly onto the adjacent wall via the kicker reflector 420 without having a dark space (as in FIG. 3) on the adjacent wall between the pool of direct light and the pool of reflected light. As shown by reference 450, any dark space is covered by the direct light or the reflected light.

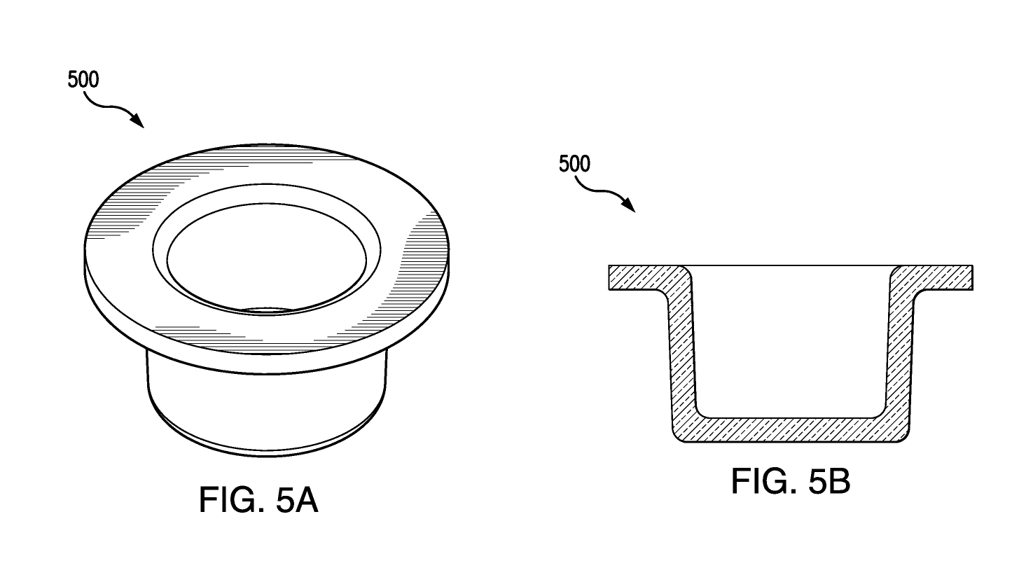

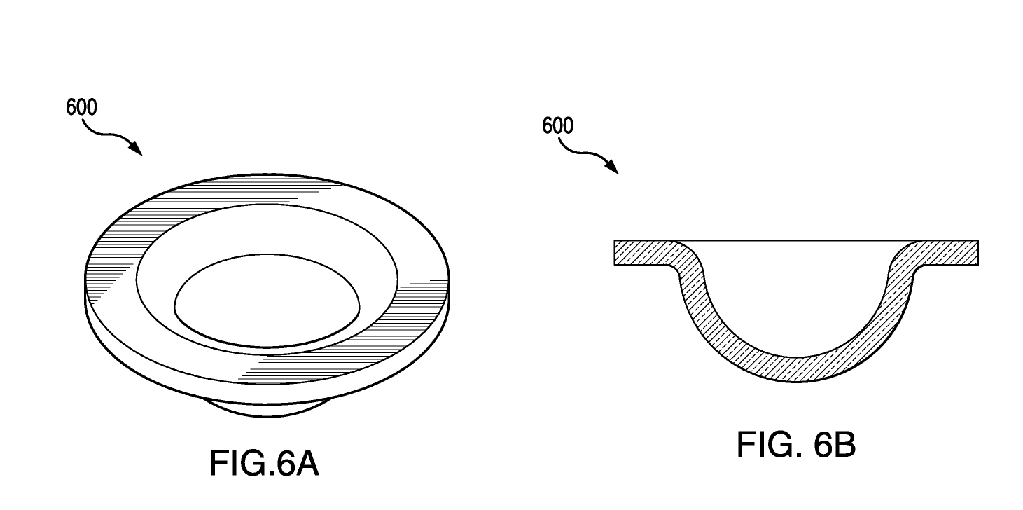

The various components of the wall wash lighting assembly can take various shapes and forms to provide a uniform light distribution pattern which eliminates a dark space on an adjacent wall. For example, the downlight trim, the light diffusing lens and the kicker reflector of a wall wash lighting assembly, such as in FIGS. 1, 2 and 4, can take on various shapes and dimensions. Examples of different exemplary light diffusing lenses 500 and 600 with elongated portions are shown in FIGS. 5A and 5B, and 6A and 6B, respectively. Furthermore, the downlight trim (e.g., 110) can be parabolic or hyperbolic.

Words of degree, such as “about”, “substantially”, and the like are used herein in the sense of “at, or nearly at, when given the manufacturing, design, and material tolerances inherent in the stated circumstances” and are used to prevent the unscrupulous infringer from unfairly taking advantage of the invention disclosure where exact or absolute figures and operational or structural relationships are stated as an aid to understanding the invention.

While particular embodiments and applications of the present disclosure have been illustrated and described, it is to be understood that the present disclosure is not limited to the precise construction and compositions disclosed herein and that various modifications, changes, and variations can be apparent from the foregoing descriptions without departing from the invention.

1. A wall wash lighting assembly for a recessed light fixture mountable on a ceiling, comprising:
a downlight trim having an upper opening, a lower opening and a cavity therebetween;
a kicker reflector, arranged in the cavity of the downlight trim, to reflect light toward an adjacent wall through the lower opening; and
a light diffusing lens to receive light from an LED light source and to output diffused light into the cavity of the downlight trim, the light diffusing lens having an elongated portion vertically extending toward the lower opening of the downlight trim, the light diffusing lens to provide a pool of direct light onto the adjacent wall via the elongated portion and a pool of reflected light indirectly onto the adjacent wall via the kicker reflector without having a dark space on the adjacent wall between the pool of direct light and the pool of reflected light.

2. The wall wash lighting assembly of claim 1, wherein the light diffusing lens has a cross-sectional bell curve shape.

3. The wall wash lighting assembly of claim 1, wherein the light diffusing lens has a cross sectional shape which tapers as the elongated portion extends from around the upper opening toward the lower opening of the downlight trim.

4. The wall wash lighting assembly of claim 1, wherein the downlight trim has a trim height from the upper opening to the lower opening, and the elongated portion of the light diffusing lens has a lens height between about one-third and one-half of the trim height.

5. The wall wash lighting assembly of claim 1, wherein the light diffusing lens further extends horizontally to cover the upper opening of the downlight trim.

6. The wall wash lighting assembly of claim 1, wherein the elongated portion of the light diffusing lens is extended toward the lower opening to have the pool of reflected light distributed on the adjacent wall vertically higher toward the ceiling.

7. The wall wash lighting assembly of claim 1, wherein the light diffusing lens is positioned above, in or below the upper opening of the downlight trim.

8. The wall wash lighting assembly of claim 1, wherein the downlight trim is a parabolic or hyperbolic downlight trim and the kicker reflector is a partial parabolic kicker reflector.

9. The wall wash lighting assembly of claim 1, wherein the downlight trim includes a window portion that is cut out and has the kicker reflector fitted therein.

10. The wall wash lighting assembly of claim 1, wherein the light diffusing lens is arranged adjacent to and below the LED light source.

11. The wall wash lighting assembly of claim 1, wherein the LED light source is connected to a mounting frame in the ceiling, and the downlight trim is mounted to the mounting frame with the light diffusing lens arranged adjacent to and below the LED light source.

12. The wall wash lighting assembly of claim 1, wherein the light diffusing lens comprises a light shaping lens.
